(19) United States
(12) Patent Application Publication
(10) Pub. No.: US 2005/0175382 A1
(43) Pub. Date: Aug. 11, 2005

(54) Storage member for used toner of printer

(75) Inventor: Dae-Seob Kweon, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/038,459

(22) Filed: Jan. 21, 2005

(30) Foreign Application Priority Data
Jan. 24, 2004 (KR) 10-2004-0004565

(51) Int. Cl. G03G 21/12

(52) U.S. Cl. 399/360

(57) ABSTRACT

A storage member to receive used toner in a printer may be installed in and removed from the printer with the inlet to the storage member closed. The storage member includes a housing that stores the used toner retrieved from the printer. An inlet forms a path through which the used toner is induced at an upper portion of the housing. A shutter slides to open and close the inlet. A shutter opening and closing rib moves the shutter linearly to open and close the inlet. An elastic member connects the shutter and the upper portion of the housing, and is elastically biased to maintain the shutter in a closed position.

### BACKGROUND OF THE INVENTION

This application claims the benefit under 35 U.S.C. § 119(a) of Korean Patent Application No. 2004-4565, filed on Jan. 24, 2004, in the Korean Intellectual Property Office, the entire disclosure of which is hereby incorporated reference.

1. Field of the Invention

The present invention relates to a storage member for used toner of a printer. More particularly, the present invention relates to a shutter opening and closing device of a storage member for used toner of a printer.

2. Description of the Related Art

Laser printers for computer and copying machines typically use either a dry type developing method that uses powder toner or a liquid type developing method that uses developing solution in which a liquid carrier and toner are mixed. Both methods use an electrophotographic developing method that transfers charged toner or developing solution to a photosensitive medium on which an electrostatic latent image is formed. A sheet of paper is pressed between the photosensitive medium and a transfer medium, which rotates while contacting the photosensitive medium to print a desired image on the sheet of paper.

Printers of the dry type using the powder toner include an optical unit that forms the electrostatic latent image on the photosensitive drum, a developing unit that attaches the toner onto the photosensitive drum, and a transfer unit that transfers the toner from the photosensitive drum onto the recording medium. A fusing unit permanently fuses the toner transferred on the recording medium onto the recording medium.

Since a lifespan of the photosensitive drum in the printer is limited, the photosensitive drum should be replaced after being used for a predetermined amount of time. Thus, to use the photosensitive drum effectively during the lifespan of the photosensitive drum, it is desirable that impurities such as toner do not remain on the photosensitive drum.

Thus, a conventional printer retrieves used toner remaining on the photosensitive drum by using a remaining toner removal unit, such as a cleaning blade. The retrieved toner (hereinafter, referred to as used toner) is transferred by an auger to storage for the used toner.

FIG. 1 is an exploded perspective view of a shutter device of a conventional storage member for the used toner.

Referring to FIG. 1, the storage for the used toner 10 disposed in the printer includes a housing 11 that has a space where the retrieved used toner is stored. An inlet 12 that is connected to a used toner outlet of a used toner carrying unit 30 is formed on an upper portion of the housing 11. The used toner is induced into the housing 11 through the inlet 12.

A shutter 20 that opens and closes the inlet 12 by sliding linearly is installed on an upper portion of the inlet 12. The shutter 20 closes the inlet 12 before the storage member for the used toner 10 is mounted on the printer and when the storage for the used toner 10 is separated from the printer, and opens the inlet 12 when the storage is mounted on the printer to perform as the storage member for the used toner 10.

The used toner carrying unit 30 is fixedly attached to a main body of the printer, and includes an inclined surface 31 on a side thereof. A first boss 21 is formed on an upper portion of the shutter 20. The first boss 21 is moved along the inclined surface 31 to open the inlet 12 when the storage member for the used toner 10 is mounted in the printer. A second boss 22 is formed on a lower portion of the shutter 20. A third boss 15 is formed on an upper portion of the storage for the used toner 10. In addition, a torsion spring 27 is connected between the second boss 22 and the third boss 15. The torsion spring 27 is elastically biased to maintain the closed status of the shutter 20.

Protrusions 24 are formed on opposite sides of the shutter 20. Slots 17 that guide the protrusions 24 to be linearly slid are formed on both opposite sides of the inlet 12.

When the storage member for the used toner 10 is mounted to a lower portion of the used toner carrying unit 30, the first boss 21 is induced inwardly along the guide surface 31. Here, the shutter 20 is slid in the left direction in FIG. 1, thereby opening the inlet 12.

When the storage member for the used toner 10 is separated from the used toner carrying unit 30, the shutter 10 is returned to the original state by the recovery force of the torsion spring 27 to close the inlet 12.

However, the shutter 20 of the conventional storage member for the used toner 10 opens the inlet 12 when the storage member for the used toner 10 is separated from the printer, thus generating a contamination inside the printer due to the scattering of the toner around the inlet 12.

Accordingly, a need exists for a storage member that prevents contamination of the printer when the waste toner storage member is removed.

### SUMMARY OF THE INVENTION

Embodiments of the present invention provide a storage member for the used toner of a printer. The storage member for the used toner includes a shutter device that enables opening and closing operations of the storage for the used toner to be performed together with opening and closing operations of a printer cover.

According to an aspect of the present invention, a storage member in a printer includes a housing that stores the used toner retrieved from a printer. An inlet forms a path through which the used toner is induced at an upper portion of the housing. A shutter slidingly opens and closes the inlet. A shutter opening and closing rib linearly slides the shutter to open and close the inlet. An elastic member connects the shutter and the upper portion of the housing and is elastically biased to maintain the shutter closed.

The shutter opening and closing rib may be formed on an inner surface of a side cover of the printer.

The shutter opening and closing rib may be formed perpendicularly to a sliding direction of the shutter.

An inclined surface may be formed at a side of the shutter opening and closing rib, and a guide surface may be formed at the upper portion of the shutter to correspond to the inclined surface of the shutter opening and closing rib.

In the storage member for the used toner of the printer, since the inlet of the storage for the used toner is opened and closed by the shutter opening and closing rib, attaching and separating of the storage member may be performed when the shutter is closed, thus preventing the used toner from scattering at the used toner inlet of the storage member.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a shutter of the conventional storage for used toner;

FIG. 2 is an exploded perspective view of a storage member for used toner according to an embodiment of the present invention;

FIG. 3 is a perspective view of a shutter opening and closing rib shown in FIG. 2 that is formed on an inner surface of a side cover of a printer; and

FIGS. 4 through 6 are views showing operations of the shutter in the storage member of FIG. 2.

Throughout the drawings, like reference numbers will be understood to refer to like parts, components and structures.

### DETAILED DESCRIPTION OF EXEMPLARY EMBODIMENTS

Hereinafter, a storage member for used toner in a printer according to exemplary embodiments of the present invention will be described in detail with reference to the accompanying drawings. Thicknesses and volumes of regions shown in the drawings are exaggerated for clarity of the specification.

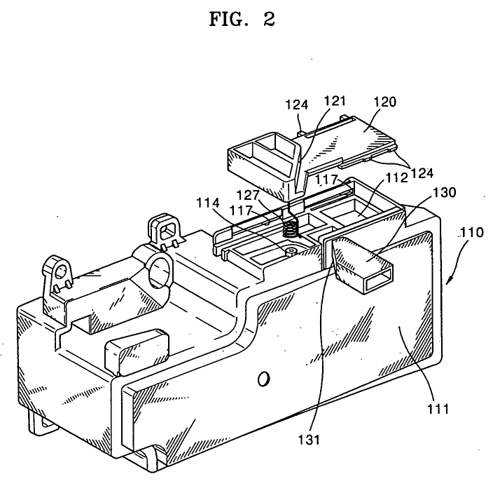

FIG. 2 is an exploded perspective view of a storage member for the used toner in a printer according to a preferred embodiment of the present invention. The same reference numerals are used for elements similar to those of the conventional art and detailed descriptions for those elements will be limited.

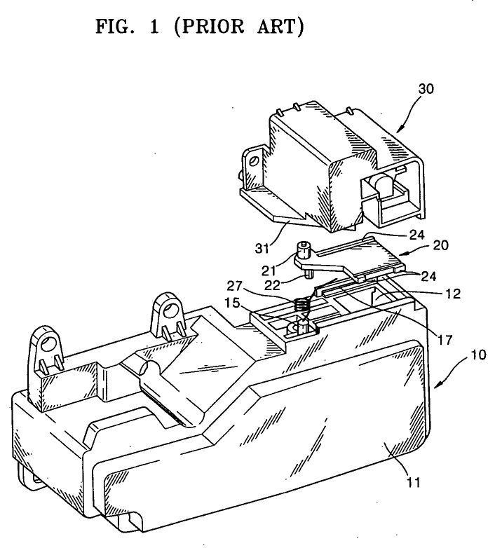

Referring to FIG. 2, the storage member 110 for the used toner includes a housing 111 that has a space where the used toner retrieved from the printer is stored. An inlet 112 connected to a used toner outlet of a used toner carrying unit (30 in FIG. 1) is formed on an upper portion of the housing 111. The used toner is transferred into the housing 111 through the inlet 112.

A shutter 120 that opens and closes the inlet 112 by sliding linearly is installed on an upper portion of the inlet 112. A guide surface 121 is formed on an upper portion of the shutter 120. The guide surface 121 corresponds to the inclined surface (31 in FIG. 1), and guides a shutter opening and closing rib 130.

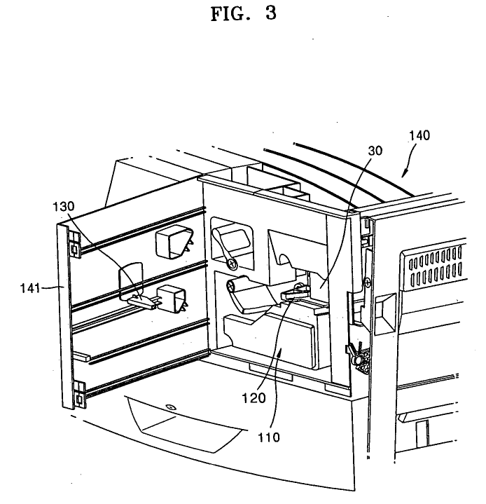

The shutter opening and closing rib 130 includes an inclined surface 131 on a side thereof that corresponds to the guide surface 121. The shutter opening and closing rib 130 may be separated from the storage member 110 for the used toner, and protrudes on an inner surface of a side cover 141 of the printer 140, as shown in FIG. 3.

An elastic member, such as a torsion spring 127, is installed between the shutter 120 and the housing 111. An upper end of the torsion spring 127 is connected to a lower portion of the shutter 120, and a lower end of the torsion spring 127 is fixed on a fourth boss 114 that is formed on an upper portion of the housing 111. Protrusions 124 are formed on opposite sides of the shutter 120, and slots 117 are formed on opposite sides of the inlet 112 to guide the protrusions 124 to slide linearly within the slots.

FIGS. 3 through 6 show the shutter 120 in the storage member 110 for the used toner according to an embodiment of the present invention.

Referring to FIGS. 3 through 6, operation of the shutter 120 in the storage member 110 for the used toner will be described in detail.

The side cover 141 of the printer 140 is opened, and the storage member 110 for the used toner is installed inside the printer 140. While the storage member 110 for the used toner is installed in the printer 140, the shutter 120 is in the closed position.

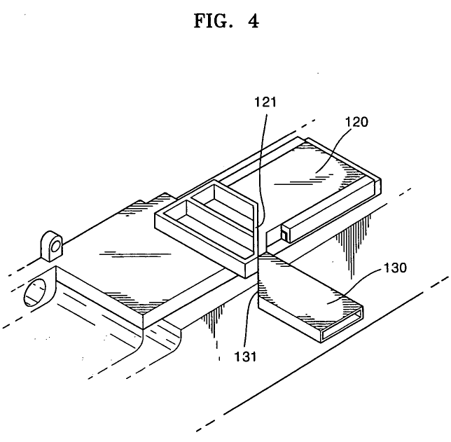

Then, when the side printer cover 141 is closed, the inclined surface 131 of the shutter opening and closing rib 130 that is attached to the inner surface of the cover 141 is engaged with the guide surface 121 (refer to FIG. 4).

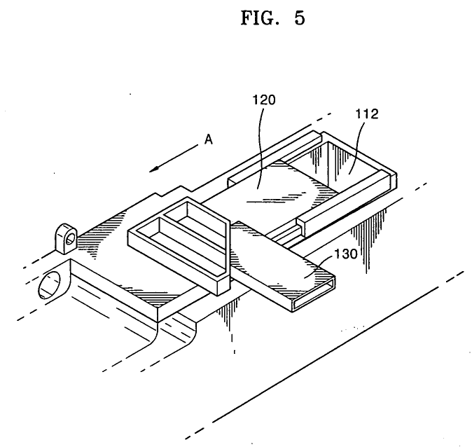

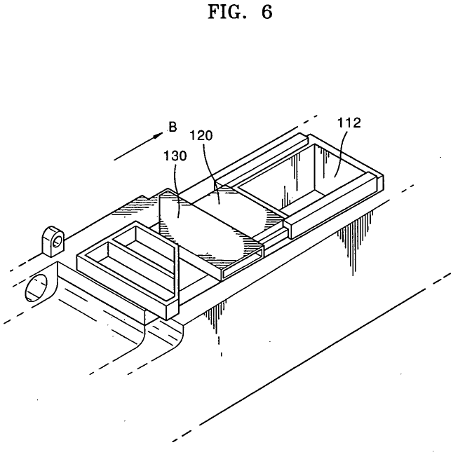

In addition, the inclined surface 131 of the shutter opening and closing rib 130 moves inwardly, and the shutter 120 is moved a direction indicated by arrow A, as shown in FIG. 5. Accordingly, the torsion spring 127 is extended in the direction indicated by arrow A (refer to FIG. 5). The shutter opening and closing rib 130 prevents the torsion spring 127 from returning to the original position. FIG. 6 shows a position in which the inlet 112 is completely open when the cover 141 is completely closed.

The shutter 120 closing operation will now be described with reference to the drawings.

When the cover 141 is opened, the shutter opening and closing rib 130 is pulled away from the storage member 110. Here, a recovering force of the torsion spring 127 moves the shutter 120 linearly in a direction indicated by arrow B to close the inlet 112, as shown in FIG. 6.

In the storage member 110 for the used toner of the printer according to an embodiment of the present invention, since the inlet 112 of the storage member for the used toner is opened and closed by the movement of the shutter opening and closing rib, attaching and separating of the storage member may be performed in a condition in which the shutter is closed, thus preventing the used toner from scattering at the used toner inlet of the storage.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A storage member for used toner in a printer, comprising:
a housing to store the used toner retrieved from the printer;
an inlet in the housing through which the used toner is transferred to the housing;
a sliding shutter to open and close the inlet;
a shutter opening and closing rib that engages and linearly slides the shutter to open and close the inlet; and
an elastic member connecting the shutter to the housing, the elastic member being elastically biased to maintain the shutter in a position to close the inlet.

2. The storage member of claim 1, wherein
the shutter opening and closing rib is formed on an inner surface of a side cover of the printer.

3. The storage member of claim 2, wherein
the shutter opening and closing rib is formed substantially perpendicularly to a sliding direction of the shutter.

4. The storage member of claim 1, wherein
an inclined surface is formed at a side of the shutter opening and closing rib, and a guide surface is formed at the upper portion of the shutter to correspond to the inclined surface of the shutter opening/closing rib.

5. The storage member of claim 1, wherein
a plurality of tabs extend outwardly from opposite sides of the shutter.

6. The storage member of claim 5, wherein
a plurality of slots are formed in the housing proximal the inlet to facilitate linear sliding movement of the shutter.

7. The storage member of claim 1, wherein
the elastic member is a torsion spring.

8. The storage member of claim 1, wherein
the elastic member is secured to a boss connected to the housing.

9. The storage member of claim 1, wherein
a first end of the shutter opening and closing rib is secured to a cover of the printer, and a second end of the shutter opening and closing rib is adapted to engage the shutter.

10. A method of opening and closing an inlet to a storage member in a printer, comprising the steps of:
slidably positioning a shutter over the inlet to the storage member in a first position to close the inlet;
securing a shutter opening and closing rib to a cover of the printer;
engaging the shutter opening and closing rib with the slidable shutter by closing the printer cover; and
sliding the shutter to a second position to open the inlet by substantially completely closing the printer cover.

11. The method of opening and closing an inlet to a storage member in a printer of claim 10, further comprising
opening the printer cover to disengage the shutter opening and closing rib from the shutter;
substantially completely opening the printer cover to move the shutter to the closed position to seal the inlet to the storage member; and
removing the storage member from the printer with the inlet sealed prior to removal of the storage member.
